(19) United States
(12) Patent Application Publication
(10) Pub. No.: US 2010/0036946 A1
(43) Pub. Date: Feb. 11, 2010

(54) SYSTEM AND PROCESS FOR PROVIDING ONLINE SERVICES

(76) Inventor: Kim von Arx, Ottawa (CA)

Correspondence Address: SMART & BIGGAR, 438 UNIVERSITY AVENUE, SUITE 1500, BOX 111, TORONTO, ON, M5G 2K8, CA

(21) Appl. No.: 12/104,065

(22) Filed: Apr. 16, 2008

Related U.S. Application Data
(60) Provisional application No. 60/949,811, filed on Jul. 13, 2007.

(51) Int. Cl. G06F 15/173

(52) U.S. Cl. 709/225; 709/226

(57) ABSTRACT

The present invention provides a system and process for providing online services. In general, the system provides a plurality of users access to an online service via one or more user modules communicatively linked to the system over a communication network. The system generally comprises a registration module for enabling one or more individualised domain names, each one of which comprising identifying information related to one or more of the users a service provider module configured to provide the one or more user modules access to the online service over the communication network, wherein access is provided to a given one of said users via a corresponding one or more of said individualised domain names comprising identifying information related thereto; and a monitoring module configured to monitor new domain names enabled by said registration module to provide a desired level of uniqueness for each of the one or more individualized domain names.

### CROSS-REFERENCE TO RELATED APPLICATIONS

This application claims benefits from U.S. Provisional Patent Application No. 60/949,811 filed Jul. 13, 2007, the contents of which are hereby incorporated herein by reference.

### FIELD OF THE INVENTION

The present invention pertains to the field of online services and, in particular, to a system and process for providing online services.

### BACKGROUND

With the explosive growth of the internet, most companies now provide services to customers over the internet, generally by means of a central web site.

For example, increasing numbers of web merchants provide websites that a user (e.g., an existing or potential customer) who is considering purchasing or who plans to purchase a product or service can access to view information about the product or service, place an order, and provide information, such as payment and shipping information, needed to complete the purchase online. The user typically provides an account number (e.g., credit card account number, debit card account number, checking account number, etc.) as part of the payment information.

Similarly, increasing numbers of financial institutions are also providing their customers online services over the web. For example, many banks now provide their customers the ability to perform numerous online transactions, such as online banking, online funds transfer, online bill payment, online trading, etc., over the web. In a typical online banking transaction, the user provides identification information, such as an account number and password, to gain remote access to the user's account. The user then requests one or more online transactions that involve the accessed account.

The expansion of online services has also led to a corresponding growth in fraudulent activities designed to take advantage of consumers using online services. Examples of fraudulent activities include typosquatting, pharming, and phishing.

Typosquatting involves the registration of domain names which are confusingly similar to domain names used by legitimate service providers. Generally, such confusing domain names capitalize on common misspellings of words, misspellings based on typing errors, pluralisation, or domain names that incorporate a different top-level domain, such as .com rather than org. Generally, when a user arrives at a typosquatter's website they are either led to believe that they are at the legitimate company's website or are directed to competitors' services. Typosquatters can be combated by filing complaints through established domain name complaint systems or through the court system. Current practices and standards in the field, however, make it difficult to do so efficiently.

Pharming is term used to describe various techniques which aim to redirect a website's traffic to another website. Examples of pharming methods include changing files on a victim's computer or exploiting vulnerabilities in domain name server software.

Phishing is generally defined as criminal activity that uses social engineering techniques. Phishers attempt to fraudulently acquire sensitive information, such as usernames, passwords, social security number, and credit card details, by masquerading as a legitimate entity. Phishing is typically carried out by email or instant messaging, and often directs users to provide sensitive information at a website. Often the website incorporates typosquatting to trick users into visiting a website that appears to belong to a legitimate company. In some cases, accessing the phisher's website causes malicious software to be installed on the user's computing device.

Various attempts to minimise the impact of phishing attacks are known in the art. Some examples include, U.S. Pat. No. 7,200,576 to Steeves et al., which discloses the use of digital watermarks to ensure the authenticity of a legitimate website; U.S. Pat. No. 7,100,049 to Gasparini et al., which discloses a system that provides an encrypted, signed cookie on a user's computer system to allow a web site to identify and authenticate the user; US Publication No. 20070136806 to Berman, Reuben, which discloses methods of automatically authenticating a URL through a phishing inspection utility to determine whether it is part of a phishing attack; and US Publication No. 20070112814 to Cheshire, Stuart D., which discloses a system wherein a URL is automatically compared against a list of trusted websites. A URL which does not match the list generates a warning message to the user.

There remains, however, a need for a new system and process that overcomes some of the drawbacks of known systems. The above and other such solutions are generally technically complex and difficult to apply, making it difficult for users to distinguish between legitimate domain names and confusingly similar domain names used by typosquatters and phishers.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a system and process for providing online services. In accordance with an aspect of the present invention, there is provided a system for providing a plurality of users access to an online service via one or more user modules communicatively linked to the system over a communication network, the system comprising: a registration module configured to enable one or more individualised domain names, each one of which comprising identifying information related to one or more of the users; a service provider module configured to provide the one or more user modules access to the online service over the communication network, wherein access is provided to a given one of said users via a corresponding one or more of said individualised domain names comprising identifying information related thereto; and a monitoring module configured to monitor new domain names enabled by said registration module to provide a desired level of uniqueness for each of the one or more individualized domain names.

In accordance with another aspect of the present invention, there is provided a process for creating a group of related domain names, said process comprising the following steps: providing a list of data identifying a plurality of users from a first source; registering a plurality of individualised domain names with a second source, wherein each of said plurality of individualised domain names contains data that identifies one or more of said plurality of users; providing said plurality of users access to their corresponding one or more of said individualised domain names; and monitoring said second source to enhance security of said plurality of individualised domain names.

In accordance with a further aspect of the present invention, there is provided a system for providing one or more users access to an online service, said system comprising: one or more user modules; one or more individualised domain names each incorporating therein at least one piece of identifying information corresponding to one or more of said one or more user modules; a service provider module configured to provide one or more online services to each of said one or more user modules via a corresponding one of said one or more individualised domain names over a communication medium; wherein said one or more user modules interact with said service provider module through said corresponding individualised domain name to access said one or more online services.

In accordance with a further aspect of the present invention, there is provided a method for a service provider module to provide online services to a user module one or more users, said method comprising the steps of: compiling a list of identifying information, wherein each piece of identifying information corresponds to at least one of the one or more user modules; generating an individualised domain name for at least one of the one or more user modules, wherein each said individualised domain name incorporates one or more pieces of identifying information corresponding said one or more users; and providing the online service to said one or more users via a corresponding individualised domain name; wherein said one or more users only interact with said service provider via said individualised domain name.

### BRIEF DESCRIPTION OF THE FIGURES

FIG. 1 is a diagram illustrating components of a system for providing online services, in accordance with one embodiment of the present invention.

FIG. 2 is a flow chart illustrating steps for creating individualized domain names in accordance with one embodiment of the present invention.

FIG. 3 is a diagram illustrating steps outlined in FIG. 2 and further identifying ways in which different components of a system for implementing same interact, in accordance with one embodiment of the present invention.

FIG. 4, is a diagram illustrating how one embodiment of the present invention can be used to defeat phishing attacks.

FIG. 5, is a diagram illustrating how one embodiment of the present invention can be used to provide targeted marketing services.

### DETAILED DESCRIPTION OF THE INVENTION

### Definitions

The term “User” is used to define a person or entity that uses a user module, such as a computing device or the like, to interact with a service provider module via a communication medium, such as the internet, to access one or more services provided by a service provider enabling this service provider module.

The term “restricted access TLD” is used to define a Top-Level Domain (TLD) in which the ability to register domain names within the TLD is controlled by one or more registration modules, and/or one or more authorised individuals or groups thereof operating, enabling and/or interfacing with same, and restricted on the basis of one or more criteria, as defined for this TLD. Restricted access TLDs can include, for example, country code TLDs, and generic TLDs.

Unless defined otherwise, all technical and scientific terms used herein have the same meaning as commonly understood by one of ordinary skill in the art to which this invention belongs.

The present invention provides a system and process for providing access to one or more online services. In general, the system provides a plurality of users access to an online service via one or more user modules communicatively linked to the system over a communication network.

In one embodiment, the system comprises a registration module for enabling one or more individualised domain names, wherein each one of these individualised domain names comprises identifying information related to one or more of the users. For example, identifying information may include, but is not limited to, a user's name, telephone number, postal code, date of birth, nickname, account number, etc., a user group's name (e.g. family name, work group, social network, etc.), and the like.

The system generally further comprises a service provider module for providing the one or more user modules of this embodiment access to the online service over the communication network, wherein access is provided to a given user, or group thereof, via a corresponding individualised domain name comprising identifying information related thereto. For example, a single user may interface with the service provider module via an individualised domain name comprising the user's name and/or other personal identifying information, whereas a user member of a user group may interface with the service provider module via an individualised domain name comprising a user group name, common address, phone number of the like. Other examples of identifying information and individualised domain names will be provided further below and should become apparent to the person of ordinary skill in the art.

The system will also generally comprise a monitoring module for monitoring new domain names enabled by the registration module to identify newly created and/or accepted domain names, or again monitor new domain names for which application for registration has been filed but not yet released (e.g. as part of an automatic verification process), to identify domain names which may be confusing to the users of the system as to an authenticity thereof.

In general, and in accordance with various embodiments of the present invention, the various components of the system may be implemented and/or enabled by different parties, without departing from the general scope and nature of the present disclosure. For example, the service provider module and monitoring module may be implemented by a common party, such as one or more service providers providing access to their services via the system. For instance, a service provider may interact directly with a registration module to enable the individualised domain names related to its services, as well as monitor new domain names created and/or applied for with the registration module for the purpose of eliminating confusingly similar domains to reduce the likelihood and potential success of phishing attacks on its customers. In another example, the registration module implements both the registration module and the monitoring module as a service to one or more service providers in an attempt to reduce the fraudulent or confusing use of domains attributed thereby and/or applied for therewith. Other such examples should become apparent to the person of ordinary skill in the art upon reading the following description and examples.

In general, and as introduced above, the user module communicates with the service provider module by means of an individualized domain name registered through a registration module. According to one embodiment, the individualized domain name is registered within a restricted-access TLD. According to one embodiment, a monitoring module is provided that communicates with the registration module for the purpose of detecting domain name registrations that are potentially confusing with individualized domain names. When this occurs, the monitoring module reports the potentially confusing domain names to the service provider, for example via the service provider module or another module enabled and/or operated by the service provider.

According to another embodiment, the service provider module optionally communicates with the registration module via an intermediary, which acts to mitigate various functions and communications between the service provider module and the registration module. In one embodiment, the intermediary operates and enables the monitoring module. In another embodiment the intermediary further facilitates the compiling and registration of the individualised domain names for the service provider.

According to one embodiment, the user module accesses services provided by the service provider module through an individualised domain name rather than a generic central access point, such as a main web portal or the like. In such embodiments, it becomes much easier to distinguish between a domain name provided by the service provider module, or another such module operated by and/or affiliated with a given service provider, and one which is confusingly similar, because the individualised domain name incorporates information regarding that particular user, such as their name, date of birth, or a unique user number, for example. Users can have confidence that a domain name referencing this information is legitimate.

According to one embodiment, the individualised domain name is further used to provide an individualised online experience for a user, such as targeted marketing; news, weather or other information feeds; web widgets, personalised information or greetings; customisation based on user data such as age, gender, purchase history, language, geographical location; user-defined preferences; or other such information as will be apparent to the person of ordinary skill in the art. According to one embodiment, a webpage that a user can customize is provided through the individualized domain name.

In addition, the system, in one embodiment, can reduce lost revenue to the service provider interfacing with, operating, or implementing the system, due to typosquatting and phishing attacks, for example.

The system may also, in one embodiment, assist in user retention because of the individualised experience provided by a domain name that incorporates the user's own information. Users who prefer the personalised convenience of using their own individualised domain name may be less likely to switch services to a service provider that provides generic online services through a central web portal, for example.

According with one embodiment, the system comprises two security-enhancing features: individualised domain names that are registered within a restricted access top-level domain (TLD). In such embodiments, not only is the domain name with which a user may interact to access a given service provide security by incorporating therein identifying information related to this user, it is further secured by incorporating a restricted-access TLD, which generally facilitates monitoring and/or policing as needed. It will be appreciated by the person of ordinary skill in the art that either of the above security-enhancing features, as well as other such features substantially equivalent thereto, can be implemented independently within the present context to provide a user access to an online service, without departing from the general scope and nature of the present disclosure.

### System Modules

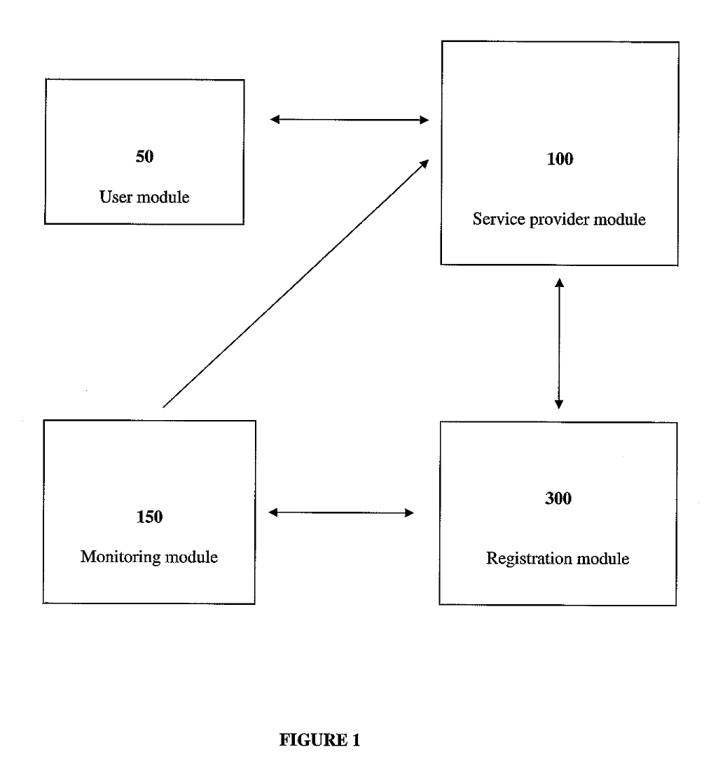

As discussed above, according to one embodiment, the system is designed to interface with one or more user modules for providing thereto access to one or more online services, and generally comprises a service provider module, a registration module, and a monitoring module, all in communication with one or more other components of the system and/or one or more user modules. With reference to FIG. 1, and in accordance with one embodiment of the present invention, the service provider module 100 communicates with the registration module 300 for the purpose of registering one or more individualised domain names. Once the individualised domain names have been registered, the user module 50 can access the one or more online services provided by the service provider module via this individualised domain name.

The monitoring module 150 generally monitors the activities of the registration module 300 to determine if domain names are being registered that are potentially confusing to the individualised domain names. The monitoring module 150 reports any potentially confusing domain names to the service provider module 100 and/or the registration module 300, for example, to reduce the likelihood and probability of success of fraudulent uses, phishing attacks and typosquatters. According to one embodiment, the monitoring module's functions are carried out by the registration module. According to one embodiment the system also comprises an intermediary who communicates with the registration module on behalf of the service provider module, for example in order to register individualised domain names on its behalf and/or partake in the monitoring process, for example. Each of these components will be discussed in greater detail below.

The service provider module generally comprises one or more computing devices in communication with one another, operated by or on behalf of a provider of online services. User modules can communicate with the service provider module in order to receive the online services. Examples of services provided by a service provider module are broad and include but are not limited to both commercial and non-commercial services, for example banking and financial services, information services, commercial services, online merchant services, gaming services, entertainment services, consultation services, professional services such as legal or accounting services, governmental services, social networking services and the like.

The intermediary is an optional component which communicates with the registration module on behalf of the service provider module and/or partakes in the monitoring process. In one embodiment, an intermediary receives information from the service provider module and provides processed information to the registration module to enable the registration module to register a group of individualised domain names for providing access to the service provider services. The intermediary may also manage the technical and logistical aspects of registering and managing the group of individualised domain names. A worker skilled in the art will be aware of the technical requirements for registering a domain name through a registration module. According to another embodiment, the system does not comprise an intermediary and the service provider module communicates with the registration module directly for the purposes of registering individualised domain names. According to yet another embodiment, the monitoring module comprises the intermediary.

The registration module generally comprises one or more computing devices operated by or on behalf of any entity capable of enabling the registration of a domain name. Examples of such entities without limiting the generality of the foregoing, can include any one or any combination of the following: an entity who has been accredited as a domain name registry by a domain name authority such as the Internet Corporation for Assigned Names and Numbers or the Internet Assigned Numbers Authority; a national country code TLD authority; an entity who has been accredited as a domain name registrar by a domain name registry or national country code TLD authority; an agent of any of the above entities; an entity who provides domain name registration services in association with one or more of the above entities; and the like.

According to one embodiment, the registration module controls registration of domains incorporating a particular Top-level Domain (TLD) based on specific guidelines. According to one embodiment, the registration module completely controls access over who can register a domain name within a TLD and can set policies regarding such access.

According to one embodiment, the various modules or components of the system generally comprise one or more computing devices, or subcomponents thereof in communication with each other. In general, such computing devices may generally comprise one or more machines that will be understood by a worker skilled in the art to include any electronic device capable of and with sufficient storage and computing capability required to access and interact with other such computing devices. Examples of computing devices may include, but are not limited to, electronic devices such as computers, laptops, electronic handheld devices, cellular telephones, smart phones, personal digital assistants (PDA) and the like.

According to one embodiment, the computing device will also be understood to comprise one or more communication devices and/or interfaces with which to communicate with other computing devices, or external devices where required. The communication means will be understood by a worker skilled in the art to include necessary elements of hardware and, including, but not limited to, communication ports, wireless transmitter/receivers, wires or fiber optics; and software that allow a computing device to exchange data packets with another computing device via such hardware elements.

It will be further appreciated that the communication medium over which each module of the system may interface with another may comprise a number of external and/or internal communication media commonly known in the art. For example, a user module may communicate with a service provider module over the internet, possibly via one or wired and/or wireless links, as required by the type and communication protocols supported by that device. Namely, wireless or cellular access via a smart phone or the like may be implemented remotely to access a user's provided services, whereas a general purpose computer may be configured to access these services via one or more wired or wireless communication media, as will be understood by the person skilled in the art.

Furthermore, communication between the service provider module, the registration module, the monitoring module, and optional intermediary, may be enabled by one or more communication media depending on each respective device with which communication is to be established. As discussed above, in an embodiment wherein the monitoring module is implemented and operated by the service provider rather than a third party, these modules may be configured to form part of a same device, or be implemented within a same local and/or regional network supported by the service provider and configured to link these modules, via a same or different paths, with the user module and registration module.

Other such combinations and permutations should be apparent to the person skilled in the art, and are thus not meant to depart from the general scope and nature of the present disclosure.

### Individualised Domains

According to one embodiment, the system provides a group of individualized domain names that contain data that corresponds to the identity of one or more users of a service provided through a service provider module. According to one embodiment, all of the users in a particular group share a common factor, such as being users of the same service provider module, such as an online merchant or bank, who provides online services. According to one embodiment, there is a pre-existing relationship between the users and the service provider. As a result of this preexisting relationship, the service module has access to a database of identifying information regarding the users that has been collected through the normal process of doing business with those users.

For example, a user applies to open a savings account at a banking institution. As part of the application process, the user provides identifying information, such as their name, postal or zip code, telephone number, date of birth, etc. When the system is established, one or more pieces of data that correspond to a user are incorporated into an individualized domain name so as to create an individualized domain name that is linked to that user. A worker skilled in the art would appreciate that for security purposes sensitive information pertaining to a user should not be incorporated into an individualized domain name in its entirety. For example, a user's Social Insurance Number should not be incorporated into an individualized domain name but the last four digits of the Social Insurance Number could be incorporated without compromising the user's security.

According to one embodiment, a variety of potential individualized domain names could be reserved by a registration module. For example, a registration module could reserve any domain name within a restricted-access TLD incorporating a particular user or service provider's identifying information. For example, a corporate service provider could enter into an agreement with a registration module such that it would be the only service provider capable of registering domain names that incorporate its corporate name within that TLD. According to one embodiment, an individualized domain name could be industry or profession-specific, rather than service provider-specific. For example, banking services could be provided to a user through the individualized domain name, <bank-UserName.xx>. A worker skilled in the art would appreciate that, outside of the identifying information, the composition of the remainder of the domain name can be created at the discretion of the service provider, within limitations imposed by the domain name system.

According to one embodiment, the process of taking the list of identifying information and generating a corresponding list of identifying domain names is carried out by the service provider. According to one embodiment, this process is carried out by an intermediary. According to one embodiment the process is carried out by the registration module. According to one embodiment, a user can create their own individualized domain name.

Using the above process, namely using the user's own information as part of the individualized domain name, the user can more easily distinguish between a valid individualized domain name provided by the service provider and a confusingly similar domain name.

### Restricted Access TLD Environment

According to one embodiment of the invention, the individualized domain names are registered within a restricted-access TLD. A worker skilled in the art would appreciate that the bodies that control certain TLDs exercise greater and lesser degrees of control over who can register for a particular domain name within that TLD. For example, the relevant body that control access to ccTLDs, such as, for example, the Canadian Internet Registration Authority, which regulates the ca ccTLD, commonly require that only individuals or corporations with a presence in the relevant jurisdiction can register for domains incorporating the ccTLD. Another example is the .gov TLD, which is restricted to US governmental bodies. In this fashion, a TLD can act as an indicator or certification of some quality of the company or individual who owns the domain name. Because of the general lack of regulation of communication on the internet, legitimate online service providers have sought various means of distinguishing themselves from imitators on the Internet. Various attempts have been made to create TLDs for specific industries or professions, such as the pro TLD for professionals or the travel TLD for the travel profession. The value in these profession-specific TLDs is the assurance by the registry, registrar, or similar entity that access will be restricted to individuals or groups who meet certain qualifications such as membership in a professional body.

According to one embodiment of the invention, the individualized domain names are registered using a restricted-access TLD. According to one embodiment, the registration module only registers individualized domain names on behalf of one or more service provider modules, thus ensuring that the only domain names incorporating that TLD have been verified by the registration module.

### Implementation of the System

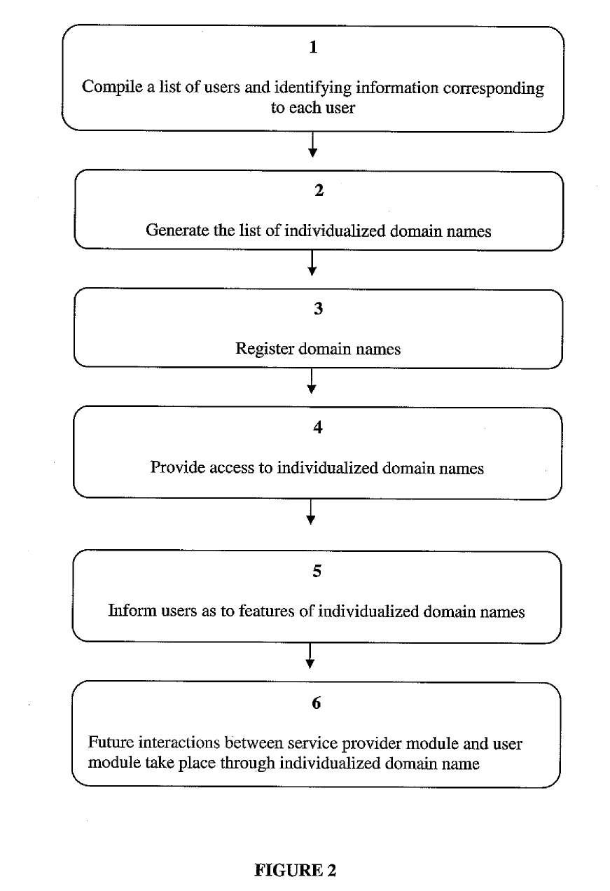

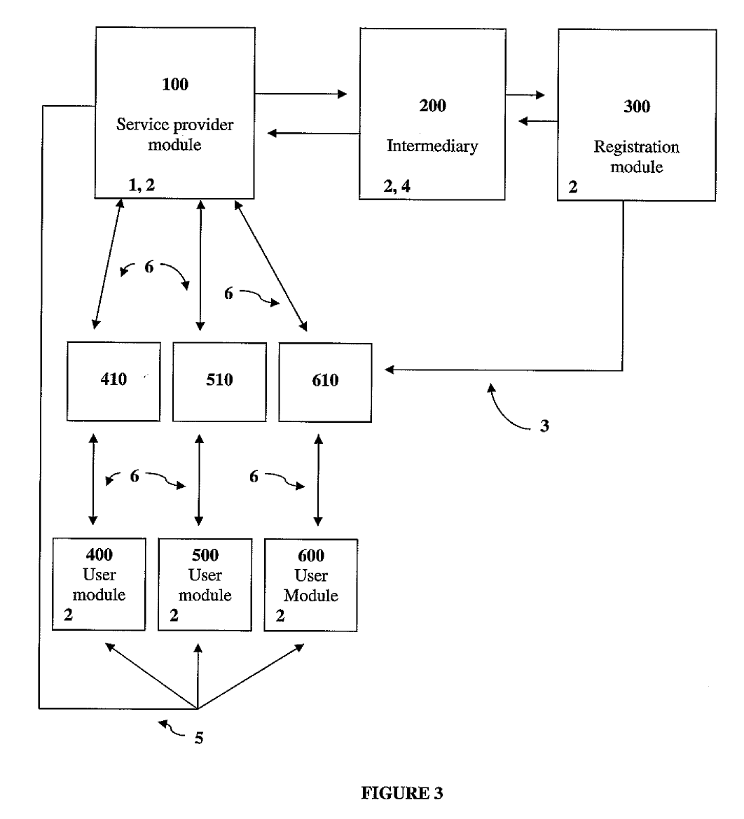

With reference to FIGS. 2 and 3, and in accordance with one embodiment of the present invention, the system can be set up by means of the following steps.

In the first step 1, the service provider module 100 generates a list of identifying information corresponding to a group of users of user modules 400, 500 and 600. The identifying information can be any piece of information that could be used to identify one or more of the users, for example and without limiting the generality of the foregoing, the name of the user, the telephone number of the user, the postal or zip code of the user, the birth date of the user, and the like. According to one embodiment, the identifying information would already be well known to the user, such as their name. According to one embodiment, the identifying information is a unique identity number provided by the service provider. According to one embodiment, more than one piece of identifying information is associated with each user.

In the second step 2, the list of identifying information is used to generate a corresponding potential list of individualized domain names 410, 510 and 610 that incorporate at least one piece of identifying information. According to one embodiment, the individualized domain names 410, 510 and 610 also incorporate additional information, such as identifying information corresponding to the service provider module 100, for example, the name of a service provider or identifying information regarding a group of service providers or a particular industry. According to one embodiment the list of potential individualized domain names includes the identifying information regarding one or more service providers, and a variable so as to reserve a certain class of potential individualized domain names. According to one embodiment, the list of potential individualized domain names 410,510 and 610 is generated by the service provider module 100. According to one embodiment, the list of identifying information is forwarded to the registration module 300, which then generates the list of potential individualized domain names 410, 510, and 610. According to one embodiment, the list of potential individualized domain names 410, 510 and 610 is generated by each of the corresponding users of user modules 400, 500 and 600 and then compiled into a list to be communicated to a registration module.

In the third step 3, a copy of the list of potential individualized domain names are communicated to a registration module 300, which enables the registration of domain names within a restricted access top-level TLD. According to one embodiment, the list of individualized domain names is generated by the registration module the communication step is not necessary. The registration module 300 proceeds to register the individualized domain names 410, 510 and 610. The process necessary to effect the registration of the domain names would be apparent to a worker skilled in the art. According to one embodiment, the application process involves providing authenticating information to the registration module regarding the service provider's entitlement to receive a domain name in the restricted-access TLD. A worker skilled in the art will appreciate that different TLDs will have different requirements and would be aware of the means to determine the necessary information required. Each individualized domain name 410, 510, and 610 comprises one or more pieces of identifying information corresponding to the user of a user module 400, 500, and 600. According to one embodiment, an individualized domain name can correspond to more than one user. For example, users in the same family could have one individualized domain name for the entire domain name incorporating identifying information about each member of the family. According to one embodiment, the individualized domain name is a second-level domain name. According to one embodiment, the intermediary registers a single second-level domain within the restricted-access TLD, and generates multiple individualized subdomain names. The subdomain names would incorporate individualized information corresponding to a user into third, fourth, fifth, etc.—level domain names. For example, the intermediary registers <example.xx> and generates individualized domain names such as <username.example.xx> or <username.userbirthdate.example.xx>. A worker skilled in the art would appreciate the necessary technical requirements needed to generate the required subdomains.

In the fourth step 4, the intermediary 200 provides access to the individualized domain names 410, 510 and 610 to the service provider module 100. A worker skilled in the art would appreciate the necessary technical means required to provide access to the individualized domain names, such as arranging for hosting of the individualized domain names on one or more servers. According to one embodiment, the service provider module hosts the individualized domain names on its servers and provides the necessary technical information to the intermediary to enable this to occur.

In the fifth step 5, according to one embodiment, the service provider module 100 informs each user module 400, 500 and 600 of the details of the individualized domain name system, enabling the user modules to distinguish between the individualized domain name and potentially fraudulent domain names, and confirming that services and information originating from the service provider module 100 will only be provided through the individualized domain names 410, 510 or 610.

In the sixth step 6, the service provider module 100 provides the user modules 400, 500 and 600 access to the individualized domain names 410, 510, and 610. Future interactions between the service provider module 100 and the user modules 400, 500 and 600 take place through the individualized domain names 410, 510 and 610.

According to one embodiment of the present invention, there is no intermediary and the service provider module registers individualised domain names by communicating directly with the registration module. According to one embodiment, the registration module provides the service of creating groups of individualized domain names to service provider modules. In this embodiment, the service provider module forwards the list identifying information to the registration module, who assumes the place of the intermediary and registration module in the steps outlined above.

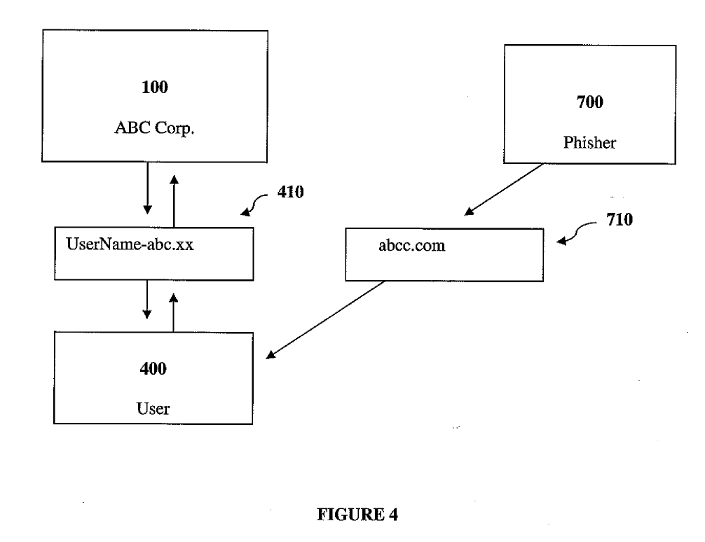

FIG. 4, is a diagram illustrating how one embodiment of the present invention can be used to defeat phishing attacks. With regard to FIG. 4, a service provider module 100, a company named “ABC Corp.” interacts with a user module 400 through an individualized domain name 410. Individualized domain name 410 incorporates the name of the user of the user module 400 and is registered within a restricted access TLD, indicated in FIG. 3 as xx. A phisher 700 sends a communication signal to the user module 400, such as an email, masquerading as the service provider module 100, and requesting that the user module 400 interact with the phisher 700 through a fraudulent domain name 710. Because the fraudulent domain name does not contain the user's identifying information and does not incorporate the restricted-access top-level domain xx, the user module 400 does not interact with the phisher 700. The phisher's attack fails and the user module's 400 security is maintained.

In order to regulate the ongoing security of the system, the restricted-access TLD can be monitored subsequent to the creation of the group of individualized domain names to prevent the registration of confusingly similar domain names within that domain. Such policing can involve various means as would be known in the art, such as regular searches. According to one embodiment, the registration module has complete discretion as to who can be granted a domain name incorporating a particular TLD and the policing involves monitoring applications for domain names.

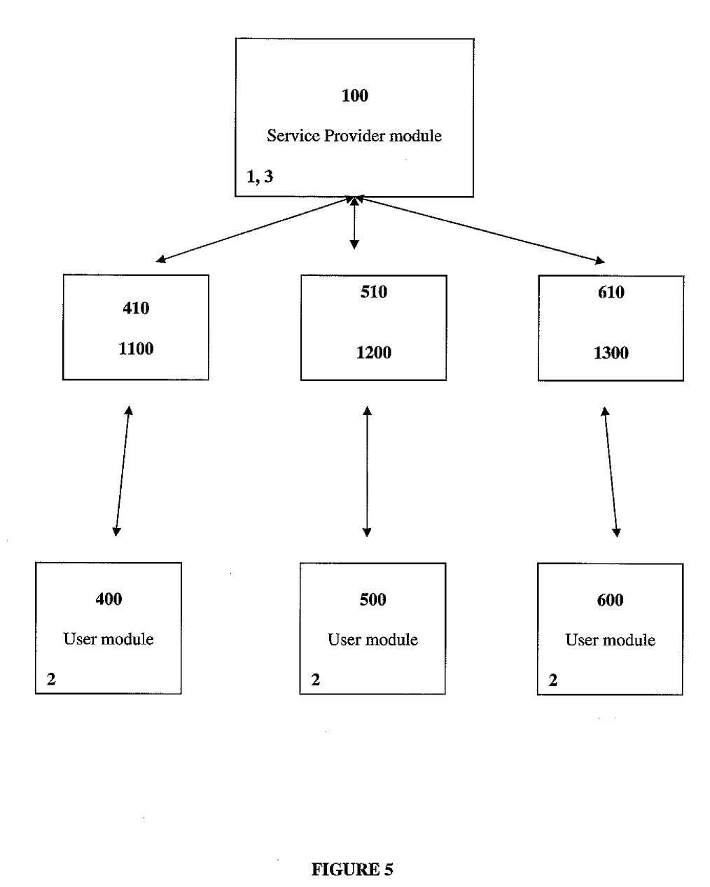

According to one embodiment, the system described herein can be used to provide targeted marketing services to users. With reference to FIG. 5, in step 1, a service provider module 100, provides online services to three user modules 400, 500 and 600 through corresponding individualized domain names 410, 510 and 610. In step 2, the user modules 400, 500 and 600 communicate information to the service provider module 100 regarding the individual preferences of the users of user modules 400, 500 and 600. The information could be provided for example, in the form of a response to a questionnaire, browsing or buying history, and the like. In step 3, the service provider module 100, analyses the information received from the user modules 400, 500 and 600 and provides access to targeted websites 1100, 1200 and 1300 through the individualized domain names 410, 510 and 610. Targeted websites 1100, 1200, and 1300 contain specific information or configurations of data designed to appeal to the users of user modules 400, 500, and 600. Such specific information or configurations could include for example information regarding specific products or services, age-specific language or different colour schemes. A worker skilled in the art would appreciate that a wide variety of customization is possible while still remaining within the scope of the invention.

The invention will now be described with reference to specific examples. It will be understood that the following examples are intended to describe embodiments of the invention and are not intended to limit the invention in any way.

### EXAMPLES

### Example 1

In this example, according to one embodiment of the present invention, the design firm One Tree Inc. is a service provider that has five users (i.e. customers) and wishes to allow them to securely review designs, place orders, and make payments online. One Tree Inc. compiles a list of identifying information regarding its five user, namely each user's name and date of birth:

| User | Identifying Info 1 | Identifying Info 2 |
|---|---|---|
| User 1 | John Brown | 613-235-4536 |
| User 2 | Suzie Green | 416-325-5641 |
| User 3 | Bob Short | 819-561-2674 |
| User 4 | Jim Smith | 519-896-1853 |
| User 5 | Jim Smith | 905-856-0189 |

One Tree Inc. contacts an intermediary through its service provider module and provides the list to them. The intermediary contacts a registration module who exercises sole control over a new restricted-access TLD, namely the .art TLD, which is reserved solely for design firms. The intermediary provides the registration module with the necessary information to confirm that One Tree Inc. is a legitimate design firm and proceeds to register five individualized domain names:

johnbrown-onetree.art

suziegreen-onetree.art

bob short-onetree.art

jimsmith1853-onetree.art

jimsmith0189-onetree.art

Because User 4 and User 5 have the same name, the intermediary incorporates both the name of the user and the last four digits of their telephone number into their individualized domain name. Once the domain names have been registered, the intermediary arranges for the domain names to be hosted on its servers and provides the service provider module access to the individualized domain names so that it can use the domain names to provide services to the five users. The intermediary then conducts regular searches of the art domain names to ensure that no confusingly similar domain names are registered that could potentially threaten One Tree Inc.'s individualized domain names.

### Example 2

In accordance with a further embodiment of the present invention, the five users of One Tree Inc., as introduced in Example 1 above, are provided access to their corresponding individualised domain name and are using it to access One Tree Inc.'s online services through the service provider module. One Tree Inc. has also informed each user that all services provided to them will be provided through their individualized domain name, which incorporates their own information and the .art TLD. Shortly thereafter, all five users receive an email purporting to originate from the service provider module. The email looks very convincing and asks each user to click on the link contained in the email to confirm their credit card information. The link contained in the email is <www.confirmation-onetree.com>. The users notice that the link does not contain their name and incorporates the .com rather than the .art TLD. As a result, they are not deceived and do not click on the link.

### Example 3

In this example, according to one embodiment of the invention, a large financial institution such as the Royal Bank of Canada (RBC) wishes to set up individualized domain names for each of its customers. RBC generates a list of its customers and decides to use the customer's name as the identifying information. To avoid the expense of registering hundreds of thousands of domain names, RBC contacts a registration module on the island of Guernsey and registers the domain name <rbc.gg>. RBC then proceeds to generate subdomains for each of its customers in the form <CustomerName.rbc.gg>. Because Guernsey represents a restricted pool of domain names, it is easier for RBC to police to identify potential typosquatters or phishers at early stages and take appropriate action against them.

### Example 4

As described in greater detail in preceding paragraphs, according to an embodiment of the present invention, the service of setting up and monitoring or policing the group of individualized domain names is provided by the registration module. In this example, a registration module controls the ability to register domain names within the .bank TLD. Only legitimate banks and financial institutions can register domain names within the .bank top-level domain. XYZ Bank, a service provider, hires the registration module to set up a group of individualized domain names for its customers. XYZ Bank provides the registration module with a list of the names of its customers. The registration module first confirms that XYZ Bank is indeed a bank established pursuant to the laws of its resident jurisdiction. The registration module then uses the list of names provided by XYZ Bank to generate a list of domain names which incorporate the name of XYZ Bank's customers. All of the individualized domain names follow the pattern <Username-XYZ.bank>. The registration module confirms the registration of the individualized domain names to XYZ Bank and provides the necessary information to allow XYZ Bank to use the individualized domain names to interact with its customers. Shortly thereafter, John Smith, an individual contacts the registration module and attempts to register the domain name XXYZ.bank. John Smith is planning to use the XXYZ.bank domain name to market products to XYZ Bank's customers who misspell the domain name. Because John Smith is not a bank or financial institution, however, the registration module will not allow him to register his domain name. The integrity of XYZ Bank's individualized domain names have been upheld due to the monitoring efforts of the registration module.

### Example 5

In this example, a XYZ Bank wishes to provide services to user modules using one or more individualized domain names that are industry or function-specific as opposed to being specific to the service provider. XYZ Bank could have various reasons for wishing to do so, but in this example it is to enable a user module to easily use multiple individualized domain names for various services offered by XYZ Bank. XYZ Bank contacts a registration module and registers four groups of individualized domain names for each of the user modules to which it provides services. All of the individualized domain names in the four groups follow the pattern, <Username-BANKING.bank>, <Username-CREDITCARD.bank>, <Username-CHECKING.bank> and <Username-SAVINGS.bank>. User modules can access the different individualized domain names to obtain personalized information regarding different services offered by XYZ Bank.

It is apparent that the foregoing embodiments of the invention are exemplary and can be varied in many ways. Such present or future variations are not to be regarded as a departure from the spirit and scope of the invention, and all such modifications as would be obvious to one skilled in the art are intended to be included within the scope of the following claims.

We claim:

1. A system for providing a plurality of users access to an online service via one or more user modules communicatively linked to the system over a communication network, the system comprising:
a registration module configured to enable one or more individualised domain names, each one of which comprising identifying information related to one or more of the users;
a service provider module configured to provide the one or more user modules access to the online service over the communication network, wherein access is provided to a given one of said users via a corresponding one or more of said individualised domain names comprising identifying information related thereto; and
a monitoring module configured to monitor new domain names enabled by said registration module to provide a desired level of uniqueness for each of the one or more individualized domain names.

2. A process for creating a group of related domain names, said process comprising the following steps:
providing a list of data identifying a plurality of users from a first source;
registering a plurality of individualized domain names with a second source, wherein each of said plurality of individualized domain names contains data that identifies one or more of said plurality of users;
providing said plurality of users access to their corresponding one or more of said individualized domain names; and
monitoring said second source to enhance security of said plurality of individualized domain names.

3. The process of claim 2 wherein the plurality of individualized domain names are registered within a restricted-access Top-level Domain.

4. A system for providing one or more users access to an online service, said system comprising:
one or more user modules;
one or more individualized domain names each incorporating therein at least one piece of identifying information corresponding to one or more of said one or more user modules;
a service provider module configured to provide one or more online services to each of said one or more user modules via a corresponding one of said one or more individualised domain names over a communication medium;
wherein said one or more user modules interact with said service provider module through said corresponding individualized domain name to access said one or more online services.

5. A method for a service provider module to provide online services to a user module one or more users, said method comprising the steps of:
compiling a list of identifying information, wherein each piece of identifying information corresponds to at least one of the one or more user modules;
generating an individualised domain name for at least one of the one or more user modules, wherein each said individualized domain name incorporates one or more pieces of identifying information corresponding said one or more users; and
providing the online service to said one or more users via a corresponding individualized domain name;
wherein said one or more users only interact with said service provider via said individualized domain name.

6. The method of claim 5, wherein said method also comprises the step of informing each of said one or more users that the individualized domain name incorporates their own identifying information so as to allow said one or more user modules to distinguish between an individualized domain name and a potentially fraudulent domain name;

7. The method of claim 6, wherein said method is used for the purpose of defeating phishing attacks on said one or more user modules.
